(19) United States
(12) Patent Application Publication
(10) Pub. No.: US 2010/0086155 A1
(43) Pub. Date: Apr. 8, 2010

(54) HEARING AID ADAPTED FOR ISSUING A NOTIFICATION AND A METHOD FOR ISSUING A NOTIFICATION

(75) Inventor: Peter Magnus NORGAARD, Varlose (DK)

Correspondence Address: SUGHRUE MION, PLLC, 2100 PENNSYLVANIA AVENUE, N.W., SUITE 800, WASHINGTON, DC, 20037, US

(73) Assignee: Widex A/S, Varlose (DK)

(21) Appl. No.: 12/634,221

(22) Filed: Dec. 9, 2009

Related U.S. Application Data
(63) Continuation-in-part of application No. PCT/DK2007/050073, filed on Jul. 13, 2007.

(51) Int. Cl. H04R 25/00

(52) U.S. Cl. 381/315; 340/309.7

(57) ABSTRACT

A hearing aid is adapted for issuing, at at least one predetermined notification time, a notification to a hearing aid user wearing the hearing aid. The hearing aid comprises digital circuitry (16, 17) including a digital processor (16), means (18) for generating a first time base for the digital circuitry (16, 17) of the hearing aid, digital storage means (13) for storing data corresponding to a time limit at which a notification is to occur, and a compensation factor value indicating a relative difference between said first time base and a second external time base. Furthermore the hearing aid comprises means for determining, based on said data indicating the predetermined notification time, said first time base and said compensation factor value, when said predetermined notification time has been reached and issuing the notification. The invention further provides a method for issuing a notification.

### RELATED APPLICATIONS

The present application is a continuation-in-part of application No. PCT/DK2007050073, filed on Jun. 13, 2007, in Denmark and published as WO2008151626 A1.

### BACKGROUND OF THE INVENTION

1. Field of the Invention

The present invention relates to hearing aids. The invention, more specifically, relates to a hearing aid adapted for issuing a notification. The invention further relates to a method for issuing such a notification.

2. The Prior Art

It is everyone's experience how useful a reminder to a specific event can be, e.g. that a pill has to be taken, or that a phone call to make an appointment with the hairdresser or the dentist has to be made.

In US-A-2006/0045278 it has been recognized that it may be useful to incorporate a notification facility into a hearing aid, so as to remind the user of a specific event, e.g. that at pill has to be taken at a specific time in order to keep correct dosage.

US-A-2006/0045278 suggests using an external device for transmitting a notification schedule and a notification message to the hearing aid, where they are stored. US-A-2006/0045278 however, does not deal with the problem of achieving sufficient precision to ensure that the notification is presented at the correct time.

While precise timing of taking a pill may be more important than the timing of the phone call, at least as long as a time limit is not exceeded, there may be other events, which call for a more precise timing, e.g. when to leave the house in order to catch a bus or a train.

In this respect, however, modern digital hearing aids generally suffer from the drawback that the built-in time base used for inter alia the digital processing is not very precise, but may deviate from a nominal value with several percent. This is because the size of crystal oscillators, which would otherwise have provided a precise time base, make them impractical in modern digital hearing aids, irrespective of the specific type of hearing aid, i.e. Behind-The-Ear (BTE), the In-The-Ear (ITE) or the Completely-In-the-Canal (CIC). Moreover, for the normal functionality of a hearing aid such precision is not needed anyway, and consequently less precise oscillator types are relied upon.

### SUMMARY OF THE INVENTION

Based on this prior art it is a feature of the present invention to provide a notification method for a hearing aid and hearing aid with a notification facility, which overcome the above mentioned problems.

According to a first aspect of the invention this feature is achieved by a hearing aid adapted for issuing, at at least one predetermined notification time, a notification to a hearing aid user wearing the hearing aid, said hearing aid comprising digital circuitry including a digital processor, means for generating a first time base for the digital circuitry of the hearing aid, digital storage means for storing data corresponding to at least one time limit at which a notification is to occur, digital storage means for storing a compensation factor value indicating a relative difference between said first time base and a second external time base, and means for determining, based on said data indicating the predetermined notification time, said first time base and said compensation factor value, when said predetermined notification time has been reached and issuing the notification.

By storing a compensation factor value indicating a relative difference between said first time base and a second external time base, the internal timekeeping of the hearing aid, and hence the determination of when a notification is to occur, becomes largely independent of any internal deviation of the internal time base from any nominal value. Instead of relying solely on the internal time base, the timekeeping of the hearing aid may in this manner be related to a far more precise external time base, such as a clock frequency derived from a crystal based oscillator. Such a crystal based oscillator generating the second, external time base could readily find place in a remote device, such as a remote control unit, which would normally be adapted for wireless communication with the hearing aid, and which would hold space for larger batteries than the hearing aid itself, which in turn allows for higher power consumption and thus for more digital processing power.

Moreover, storing or using the compensation factor value in the hearing aid, rather than e.g. relying entirely on the external time base, makes the precision of the issuance of the notification independent of the availability of the remote device. Thus, the notification can be issued at the correct time even if the remote device is not brought along with the hearing aid.

Similarly, the feature of the invention is in a second aspect thereof achieved by a method for issuing, at at least one predetermined notification time, a notification to a hearing aid user wearing a hearing aid, said method comprising: storing, in said hearing aid, data indicating the predetermined notification time when said notification is to occur, providing in said hearing aid a first time base for the determination of when the predetermined notification time has been reached, providing a second, external time base, establishing a compensation factor value indicating a relative difference between said first time base and said second time base, determining, based on said data indicating the predetermined notification time, said first time base and said compensation factor value, when said predetermined notification time has been reached and issuing the notification.

According to a preferred embodiment of the first aspect of the invention, said digital storage means for storing data corresponding to at least one time limit at which a notification is to occur are adapted to store data indicating a duration from the time when said data is stored until the notification is to occur. By simply storing the duration from the time when said data is stored until the notification is to occur the timekeeping may be realised in a very simple manner. In fact all, that is needed is storing a time value and setting or resetting an appropriate counter.

According to another preferred embodiment of the first aspect of the invention, said hearing aid comprises means for keeping an absolute time reference based on said first time base, and wherein said digital storage means for storing data corresponding to at least one time limit at which a notification is to occur are adapted to store a time value with respect to said absolute time reference. Keeping an absolute time reference may be advantageous if track is to be kept of several notifications, as multiple counters are then not needed.

According to a further preferred embodiment of the first aspect of the invention, said hearing aid comprises receiving means for receiving at least one of said data indicating the predetermined notification time and said compensation factor value from a remote device. This allows for frequent update of said stored compensation factor value, e.g. every time information about a new notification is stored in the hearing aid. Thus, the timekeeping may be precise and notifications occur at the correct time over long time spans.

According to yet another preferred embodiment according to the first aspect of the invention, said receiving means is adapted for wireless reception. This allows the necessary data to be easily transmitted to the hearing aid.

According to still a further embodiment of the first aspect of the invention, said hearing aid further comprises means for issuing a notification comprising audible words. Giving a notification including audible words increases intelligibility, and allows people who suffer from mental impairment such as dementia to better understand the notification.

Preferred embodiments of the method according to the second aspect of the invention are found in the dependent method claims. These embodiments generally present the same advantages as the embodiments of the hearing aid according to the first aspect of the invention.

### BRIEF DESCRIPTION OF THE DRAWINGS

The invention will now be described in greater detail based on non-limiting exemplary embodiments, as presented in the appended drawings. In the drawings,

FIG. 1 schematically illustrates a hearing aid according to the invention,

FIG. 2 is a block diagram schematically illustrating the notification circuitry of the hearing aid,

FIG. 3 schematically illustrates a method according to the invention, and

FIG. 4 schematically illustrates a remote device for the use with the method and hearing aid of the invention.

### DETAILED DESCRIPTION OF THE INVENTION

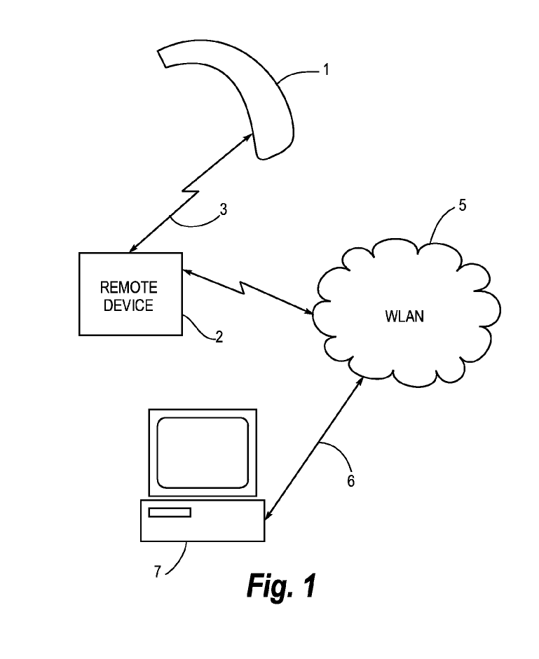

In FIG. 1 a hearing aid 1 according to the invention is schematically illustrated. The hearing aid 1 is adapted for bi-directional communication with a remote device 2 via a wireless connection 3. The wireless connection 3 is preferably a low-power radio connection with a range of maximum 1-2 metres. The remote device 2 may be connected to other devices, here exemplified as a computer 7. In the illustrated example the remote device 2 has wireless Local Area Network (WLAN) connectivity, so as to be connected to the computer 7 via their respective connections 4, 6 to the WLAN 5. Other communication means such as Bluetooth could also be implemented and used for the communication between the remote device 2 and the computer 7. The hearing aid 1 is adapted for issuing an audible notification. Preferably, the audible warning is issued using the normal circuitry of a hearing aid 1 such as the digital signal processor, an amplifier, the speaker, etc. How this is done in details is within reach of the skilled person and details will not be discussed unless relevant for this invention. Details can also be found in US-A-2006/0045278 incorporated herein by reference.

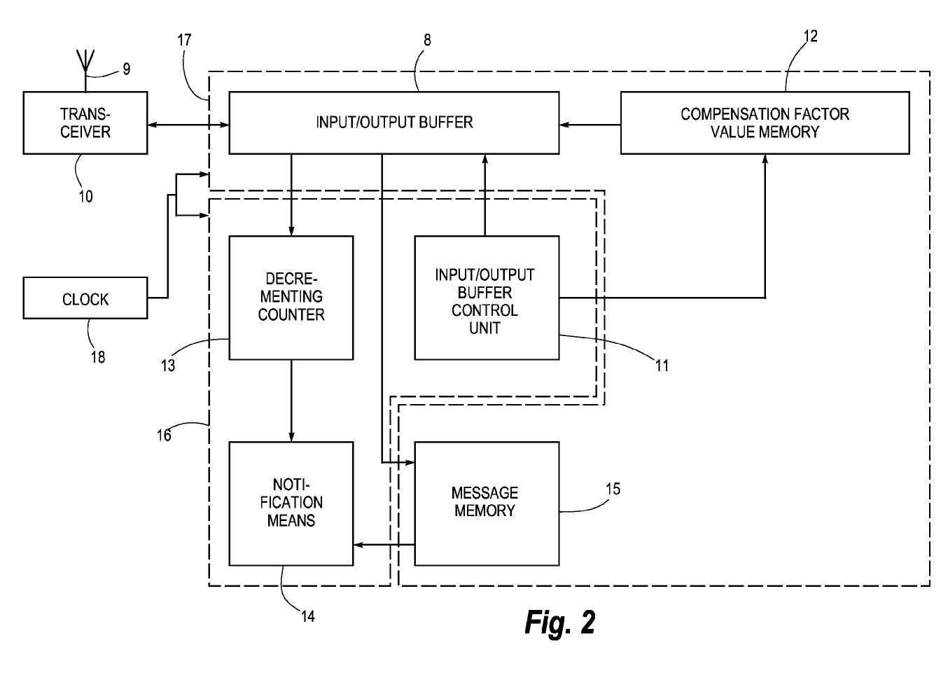

The hearing aid 1 and the remote device 2 both comprise digital circuitry. Each has its own time base or clock frequency, which may be used directly or from which other frequencies are derived. The hearing aid 1 may typically have a relatively low clock frequency, of e.g. 2 MHz, to keep power consumption down. In FIG. 2 the time base is schematically illustrated as a clock 18 providing clocking signals for both a digital signal processor 16 and memory 17. Though not illustrated, the skilled person will know that decimated or otherwise reduced frequencies may be used for the memory 17. Moreover, because the available space within the hearing aids of the BTE, ITE and CIC types mentioned above is insufficient to accommodate a crystal oscillator, other means for generating the clock frequency are typically used. Oscillators, typically used, may be relaxation oscillators, which are less precise than crystal oscillators, and may be subject to drift or variations. For the normal operation of the hearing aid, i.e. the signal processing, filtering, other processing etc., this lack of precision is not of importance, and up to five percent deviation from a nominal value may be acceptable.

However, when it comes to the timing of notifications, such a deviation is not necessarily acceptable, in particular if notification is to be made over a longer time span, such as several days. Here it should be noted that time spans over several days are only possible if the hearing aid is not switched off entirely overnight. It has however turned out that under certain circumstances powering down the hearing aid 1 to maintain only minimal functions imposes only a similar drain on the battery of the hearing aid 1, as compared to e.g. switching off the hearing aid 1 by opening the battery compartment (not shown).

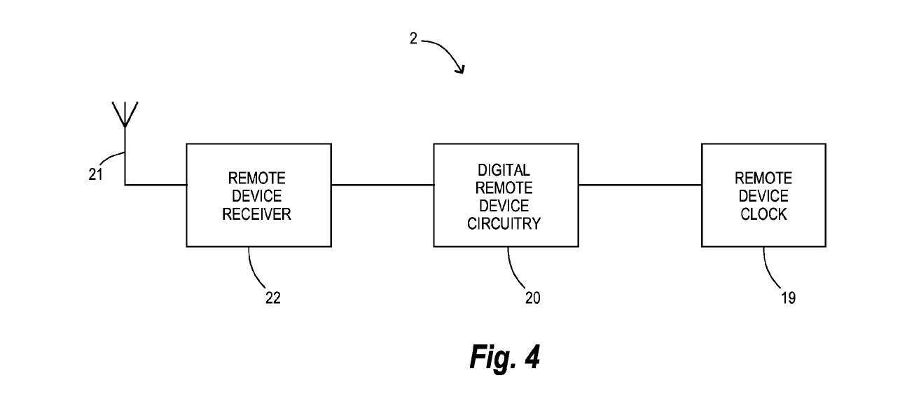

To compensate for such variations, the present invention makes use of a second more precise time base, rather than relying solely on the first time base produced in the hearing aid 1. This second time base is according to the preferred embodiment produced in a remote unit 2, by means of a crystal oscillator, providing a remote device clock 19, see FIG. 4. With the two time bases, i.e. the first time base generated internally in the hearing aid 1 by the clock 18, and the second external time base produced externally in the remote unit 2 by the remote device clock 19 it becomes possible to establish the deviation between the time bases and take this into account when using the first, less precise time base for the notification in the hearing aid 1. This established deviation may then be stored as a compensation factor value. The compensation factor value may be stored in the hearing aid 1, e.g. temporarily, before it is transmitted to the remote device 2 via the wireless connection 3. In the remote device 2 the compensation factor value may be stored in a more permanent manner as a memory forming part of the digital remote device circuitry 20.

The compensation factor value may be derived by the digital processing means in the hearing aid 1 using the input/output buffer 8 illustrated in FIG. 2. The input/output buffer 8 receives a stream of data from the remote unit 2 via an antenna 9 and a transceiver 10. Since the data stream is received as a transmission from the remote device 2, the data stream will be based on the external time base of the remote device 2, and will consequently be read into the input/output buffer 8 at a rate reflecting this time base. On the other hand it will be read out of the input/output buffer 8 at a rate reflecting the first internal time base of the hearing aid 1. An input/output buffer control unit 11 is provided, preferably implemented in the digital processor 16, to adjust the rate with which the content is read out of the input/output buffer 8, e.g. to prevent buffer overflow, and will consequently detect and keep track of inter alia the deviation in order to adjust the reading rate. Based on the detected deviation, the input/output buffer control unit 11 may store a corresponding compensation factor value in compensation factor memory 12. From the compensation factor value memory 12, the compensation factor value may be read out and transmitted to the remote device 2 via the input/output buffer 8, the transceiver 10 and the antenna 9. The compensation factor memory 12 and the input/output buffer 8 may be provided in a separate memory device 17 such as a RAM chip, or it may be integrated as part of the digital processor 16. At the remote unit 2, the compensation factor value is received by the remote device antenna 21 and the remote device transceiver 22, for the use in the digital remote device circuitry 20.

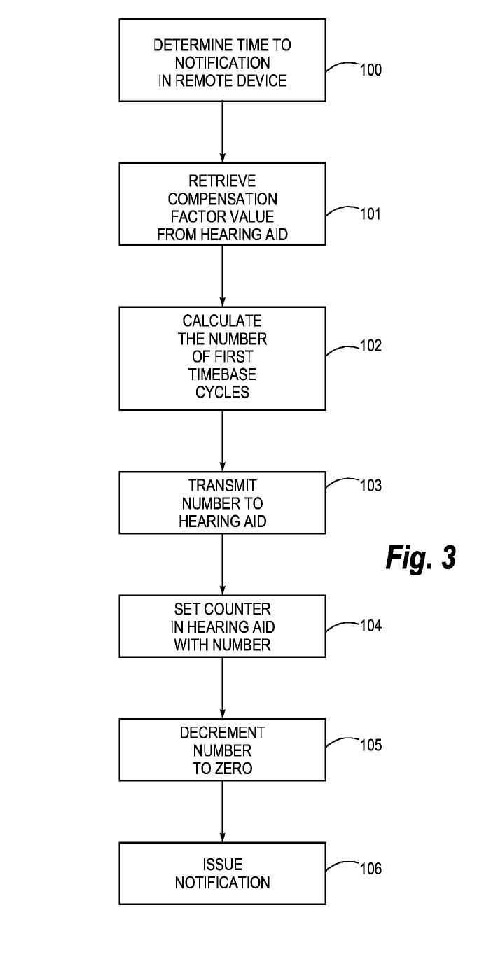

Turning now to FIG. 3, a preferred way of storing and issuing a notification in the hearing aid 1 will be described.

Starting in box 100, the time until the notification is to be issued is established. This may be done by simply keying in the time to elapse before a notification is to be issued, e.g. keying in a specific number of hours, minutes and seconds until the desired notification in the remote device, say five 5 minutes as a reminder of a pot of tea brewing. In the alternative, calendar information such as day, hour, minute and second for an event may be entered, and the corresponding time to elapse may be calculated by a digital processor forming part of the digital remote device circuitry 20 of the remote device 2.

Having determined the time to the notification, the compensation factor value from the hearing aid 1 may be retrieved in box 101. Based on the time to notification determined in box 100 and the compensation factor value retrieved in box 101, a result in the form of data representing a duration until notification, as expressed on the first time base, is calculated in box 102, e.g. as a number of clock cycles of the first time base corresponding to the desired time to the notification.

In box 103, the data representing the calculated result is transmitted to the hearing aid 1 from the remote device 2.

In box 104, the data representing the calculated result, and thus indicating the predetermined notification time when said notification is to occur, is stored, preferably by setting a start value for a counter 13 to be decremented, see FIG. 2.

After having set the counter 13 in box 104, the counter is automatically decremented in box 105 until zero is reached.

When zero has been reached, the notification is issued by the notification means 14, see FIG. 2 again. The notification means 14 is also preferably implemented as a part of the digital processor.

In respect of the above, it should be noted that depending on the actual construction of the counter in the hearing aid 1, the result corresponding to the duration until notification time may be expressed in many other ways than the full number of fundamental clock cycles. In this respect, the skilled person will know that in addition to the fundamental clock frequency, several other lower frequencies derived from the fundamental frequency are typically available in the hearing aid 1. Thus the value transmitted and stored in the counter to be decremented could be a suitable fraction of the fundamental clock cycles. Any of these lower frequencies could be used, thus saving resources for counting and storing, as lower numbers or values need to be stored in the counter 13. The hearing aid 1 thus adapted would consequently only decrement the stored value every time a corresponding number of clock cycles have passed.

Establishing such a counter 13 in the hearing aid 1, or rather a suitable number of such counters 13, in order to store and keep track of several notifications concurrently in the hearing aid 1 is presently preferred, as such counters 13 are fairly simple to implement in the digital signal processor 16.

Even though it is currently preferred to calculate a result in the form of data representing a duration until notification, as expressed on the first time base, it should be noted that it is also possible use the external time base. In that case the compensation factor value is stored in the hearing aid, and a data result corresponding to the duration until the notification, expressed on the basis of the external time base, is transmitted to and stored in the hearing aid 1 as basis for the counter 13 to be decremented. However, as this necessitates the use of processing power in the hearing aid 1 to subsequently compensate for the deviation, rather than simply decrementing a counter, this is less preferred.

As a further but also less preferred embodiment the hearing aid 1 includes itself an absolute time reference, such as a calendar, keeping track of the current time, e.g. in terms of year, month, day, hour, minute and second, using the compensation value factor and the first time base. In that case calendar data could be sent to the hearing aid 1 and stored in the memory. In that case several notification times can be stored and monitored without using a corresponding number of counters. However, since this requires even more resources in the hearing aid it is, as mentioned, less preferred.

According to a further preferred embodiment, the hearing aid 1 comprises message storage means 15, in which one or more audible messages containing words may be stored. Thus, when the result in the form of data representing a duration until notification, as expressed on the first time base, is calculated and transmitted, a message to be stored in the message storing means 15 may also be stored, the message comprising intelligible information about the nature of the notification. The messages in the message storage means 15 may also be pre-recorded, in which case only information indicating which message is associated with the notification needs to be transmitted.

When the notification means 14 is to issue a notification a message may be retrieved from the message storage means 15 and played back to the user. In order to alert the user, a precursor to the message, such as a beep may also be played back or generated.

As already mentioned, the remote device may have wireless Local Area Network (WLAN) connectivity, so as to be connectable to the computer 7 if a WLAN 5 is available. The connection to the computer 7 may be used for several different purposes. The computer 7 may run a calendar software, in which the user may store calendar events with associated notifications. These can then be transmitted to the hearing aid 1 via the WLAN 5 and the remote device 2. The computer 7 may also take over the calculating functions, which would otherwise be carried out by the remote unit 2. The computer 7 then calculates the result in the form of data representing the duration until notification, as expressed on the first time base, cf. box 102 of FIG. 3, and transmits the result to the hearing aid 1 for storage in the counter 13. If a calendar function is implemented in the remote unit 2, the computer 7 may also be used to synchronize the time settings of the remote unit 2 with a precise date and time reference such as internet time, i.e. time information downloaded from the internet. Moreover, the computer 7 may be used for recording, storing or transmitting appropriate messages to the hearing aid 1 for storage in the message memory, allowing these to be presented audibly to the user by the hearing aid 1 upon notification. The skilled person will, however, realize that these are only examples of where the computer 7 is useful in the context of the present invention.

1. A hearing aid adapted for issuing, at at least one predetermined notification time, a notification to a hearing aid user wearing the hearing aid, said hearing aid comprising
digital circuitry including a digital processor,
means for generating a first time base for the digital circuitry of the hearing aid,
digital storage means for storing data corresponding to at least one time limit at which a notification is to occur,
digital storage means for storing a compensation factor value indicating a relative difference between said first time base and a second external time base produced in a remote unit, and
means for determining, based on said data indicating the predetermined notification time, said first time base and said compensation factor value, when said predetermined notification time has been reached, and issuing the notification.

2. The hearing aid according to claim 1, wherein said digital storage means for storing data corresponding to at least one time limit at which a notification is to occur are adapted to store data indicating a duration from the time when said data is stored until the notification is to occur.

3. The hearing aid according to claim 1, wherein said hearing aid comprises means for keeping an absolute time reference based on said first time base, and wherein said digital storage means for storing data corresponding to at least one time limit at which a notification is to occur are adapted to store a time value with respect to said absolute time reference.

4. The hearing aid according to claim 1, comprising receiving means for receiving at least one of said data indicating the predetermined notification time and said compensation factor value from a remote device.

5. The hearing aid according to claim 4, wherein said receiving means is adapted for wireless reception.

6. The hearing aid according to claim 1, comprising means for issuing a notification comprising audible words.

7. A method for issuing, at least one predetermined notification time, a notification to a hearing aid user wearing a hearing aid, said method comprising:
storing, in said hearing aid, data indicating the predetermined notification time when said notification is to occur,
providing in said hearing aid a first time base for the determination of when the predetermined notification time has been reached,
providing a second, external time base,
establishing a compensation factor value indicating a relative difference between said first time base and said second time base,
determining, based on said data indicating the predetermined notification time, said first time base and said compensation factor value, when said predetermined notification time has been reached and issuing the notification.

8. The method according to claim 7, wherein said compensation factor value is stored in said hearing aid.

9. The method according to claim 7, wherein said data indicating the predetermined notification time indicates a duration from the time when said data is stored until the notification is to occur.

10. The method according to claim 7, wherein said data indicating the predetermined notification time indicates a duration from the time when said data is stored until the notification is to occur, and wherein said data indicating the predetermined notification time is compensated with the compensation factor value before it is stored in the hearing aid.

11. The method according to claim 7, wherein said data indicating the predetermined notification time indicates a time value with respect to an absolute time reference based on said first time base.

12. The method according to claim 7, wherein at least one of said data indicating the predetermined notification time and said compensation factor value are transmitted to said hearing aid from a remote device.

13. The method according to claim 12, wherein said second time base is generated in said remote device.

14. The method according to claim 12, wherein said transmission is wireless.

15. The method according to claim 7, wherein said notification comprises audible words.
